(19) United States
(12) Patent Application Publication
(10) Pub. No.: US 2022/0135070 A1
(43) Pub. Date: May 5, 2022

(54) METHOD AND DEVICE FOR CONTROLLING AUTONOMOUS DRIVING

(71) Applicants: HYUNDAI MOTOR COMPANY, Seoul (KR); KIA CORPORATION, Seoul (KR)

(72) Inventor: Chan Hee JUNG, Seoul (KR)

(73) Assignees: HYUNDAI MOTOR COMPANY, Seoul (KR); KIA CORPORATION, Seoul (KR)

(21) Appl. No.: 17/409,243

(22) Filed: Aug. 23, 2021

(30) Foreign Application Priority Data
Nov. 5, 2020 (KR) 10-2020-0147109

(51) Int. Cl. B60W 60/00; B60W 50/16; B60W 50/08

(52) U.S. Cl. CPC B60W 60/005; B60W 60/0016; B60W 2050/0067; B60W 50/082; B60W 50/16

(57) ABSTRACT

A device and a method for controlling autonomous driving in an autonomous vehicle are provided. The method may include collecting recognition information during the autonomous driving, determining whether a change in an automation level is required based on the collected recognition information, displaying a predetermined message on a screen when it is determined that the change in the automation level is required, and performing the autonomous driving by changing the automation level when it is determined that the change in the automation level is required.

### CROSS-REFERENCE TO RELATED APPLICATION

This application claims the benefit of priority to Korean Patent Application No. 10-2020-0147109, filed on Nov. 5, 2020, the entire contents of which are incorporated herein by reference.

### TECHNICAL FIELD

The present disclosure relates to autonomous vehicle control, and more particularly, to an autonomous driving control technology capable of adaptively controlling automation steps without deactivating the autonomous driving based on various information recognized during the autonomous driving.

### BACKGROUND

An autonomous vehicle may be desirable to have an ability to adaptively cope with a surrounding situation that changes in real time during travel.

For mass production and invigoration of the autonomous vehicle, a reliable determination control function is required above all.

Semi-autonomous vehicles that have been recently released basically perform driving, braking, and steering on behalf of a driver to reduce fatigue of the driver.

In a case of semi-autonomous driving, unlike fully autonomous driving, the driver has to stay focus on driving such as continuously holding a steering wheel and the like.

Recently, the semi-autonomous vehicles are being sold with a highway driving assist (HDA) function, a driver status warning (DSW) function that determines driver carelessness and state abnormalities such as drowsy driving, distraction, and the like to output a warning alarm through a cluster and the like, a driver awareness warning (DAN) function that determines whether the vehicle crosses a line and travels unstably through a front camera and the like, a forward collision-avoidance assist (FCA) or an active emergency brake system (AEBS) function that performs sudden braking when detecting a forward collision, and the like.

In a conventional autonomous driving system, when an autonomous driving condition is not satisfied, an autonomous driving mode was immediately deactivated to cause a danger to the driver. In addition, in the conventional autonomous driving system, even when the autonomous driving mode is deactivated after being confirmed by the driver, the driver had to perform another re-input procedure to operate another autonomous driving function.

### SUMMARY

An aspect of the present disclosure provides a method and a device for controlling autonomous driving.

Another aspect of the present disclosure provides a method and a device for controlling autonomous driving capable of adaptively controlling automation steps without deactivating the autonomous driving based on a change in an environment during the autonomous driving.

Another aspect of the present disclosure provides a method and a device for controlling autonomous driving capable of adaptively performing guide message output and/or driver confirmation procedures depending on whether automation level adjustment is downward adjustment or upward adjustment.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a method for controlling autonomous driving in an autonomous vehicle includes collecting recognition information during the autonomous driving, determining whether a change in an automation level is required based on the collected recognition information, displaying a predetermined message on a screen when the change in the automation level is required as the result of the determination, and performing the autonomous driving by changing the automation level based on the determination result.

In one implementation, the recognition information may include at least one of external environment recognition information, travel state recognition information, driver state recognition information, precise map information, and/or vehicle operation state information.

In one implementation, the method may further include displaying a first message including an automation level change guide phrase and buttons for determining whether a driver accepts the corresponding change in the automation level on the screen when downward adjustment of the automation level is required as the result of the determination.

In one implementation, the method may further include performing the autonomous driving after the automation level is adjusted downward in response to an acceptance response from the driver to the change in the automation level, and deactivating the autonomous driving in response to a rejection response from the driver to the change in the automation level.

In one implementation, the method may further include displaying a second message including an automation level change guide phrase on the screen, but not performing a procedure for determining whether a driver accepts the change in the automation level when upward adjustment of the automation level is required as the result of the determination.

In one implementation, the change in the automation level may include a change of two or more levels.

In one implementation, the method may further include performing the change in the automation level based on a control signal received from a human machine interface (HMI) after the message output.

In one implementation, the external environment recognition information may include at least one of line recognition state information, current travel road type information, current travel road traffic volume information, current travel road accident and construction information, current weather information, and/or communication state information.

In one implementation, the message may output using at least one of visual output means, audible output means, and/or tactile output means.

In one implementation, the method may further include outputting the message using a larger number of output means as the automation level is changed to a lower level when downward adjustment of the automation level is required, and outputting the message using a smaller number of output means as the automation level is changed to a higher level when upward adjustment of the automation level is required.

According to another aspect of the present disclosure, a device for controlling autonomous driving in an autonomous vehicle includes a recognition device that collects recognition information during the autonomous driving, a determination device that determines whether a change in an automation level is required based on the collected recognition information, a display device that displays a predetermined message on a screen when the change in the automation level is required as the result of the determination, and a change device that performs the autonomous driving by changing the automation level based on the determination result.

In one implementation, the recognition information may include at least one of external environment recognition information, travel state recognition information, driver state recognition information, precise map information, and/or vehicle operation state information.

In one implementation, a first message including an automation level change guide phrase and buttons for determining whether a driver accepts the corresponding change in the automation level may be displayed on the screen when downward adjustment of the automation level is required as the result of the determination.

In one implementation, the autonomous driving may be performed after the automation level is adjusted downward in response to an acceptance response from the driver to the change in the automation level, and the autonomous driving may be deactivated in response to a rejection response from the driver to the change in the automation level.

In one implementation, a second message including an automation level change guide phrase may be displayed on the screen, but a procedure for determining whether a driver accepts the change in the automation level may not be performed when upward adjustment of the automation level is required as the result of the determination.

In one implementation, the change in the automation level may include a change of two or more levels.

In one implementation, the change device may perform the change in the automation level based on a control signal received from a human machine interface (HMI) after the message output.

In one implementation, the external environment recognition information may include at least one of line recognition state information, current travel road type information, current travel road traffic volume information, current travel road accident and construction information, current weather information, and/or communication state information.

In one implementation, the message may be output using at least one of visual output means, audible output means, and/or tactile output means.

In one implementation, the message may be output using a larger number of output means as the automation level is changed to a lower level when downward adjustment of the automation level is required, and the message may be output using a smaller number of output means as the automation level is changed to a higher level when upward adjustment of the automation level is required.

The technical problems to be solved by the present inventive concept are not limited to the aforementioned problems, and any other technical problems not mentioned herein will be clearly understood from the following description by those skilled in the art to which the present disclosure pertains.

### DRAWINGS

The above and other objects, features and advantages of the present disclosure will be more apparent from the following detailed description taken in conjunction with the accompanying drawings:

FIG. 1 is a table in which automation levels of an autonomous vehicle are defined;

FIG. 2 is a block diagram for illustrating a structure of an autonomous driving control device in one form of the present disclosure;

FIG. 3 is a block diagram for illustrating a structure of an autonomous driving control device in one form of the present disclosure;

FIG. 4 is a flowchart for illustrating an autonomous driving level control method in an autonomous driving control device in one form of the present disclosure;

FIG. 5 is a diagram for illustrating an autonomous driving level downward adjustment procedure in one form of the present disclosure;

FIG. 6 is a view for illustrating an autonomous driving level upward adjustment procedure in one form of the present disclosure; and

FIG. 7 is a flowchart for illustrating an operating mechanism of an autonomous driving control device in one form of the present disclosure.

### DETAILED DESCRIPTION

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing some forms of the present disclosure, a detailed description of well-known features or functions will be ruled out in order not to unnecessarily obscure the gist of the present disclosure.

In describing some forms of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific tenns, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

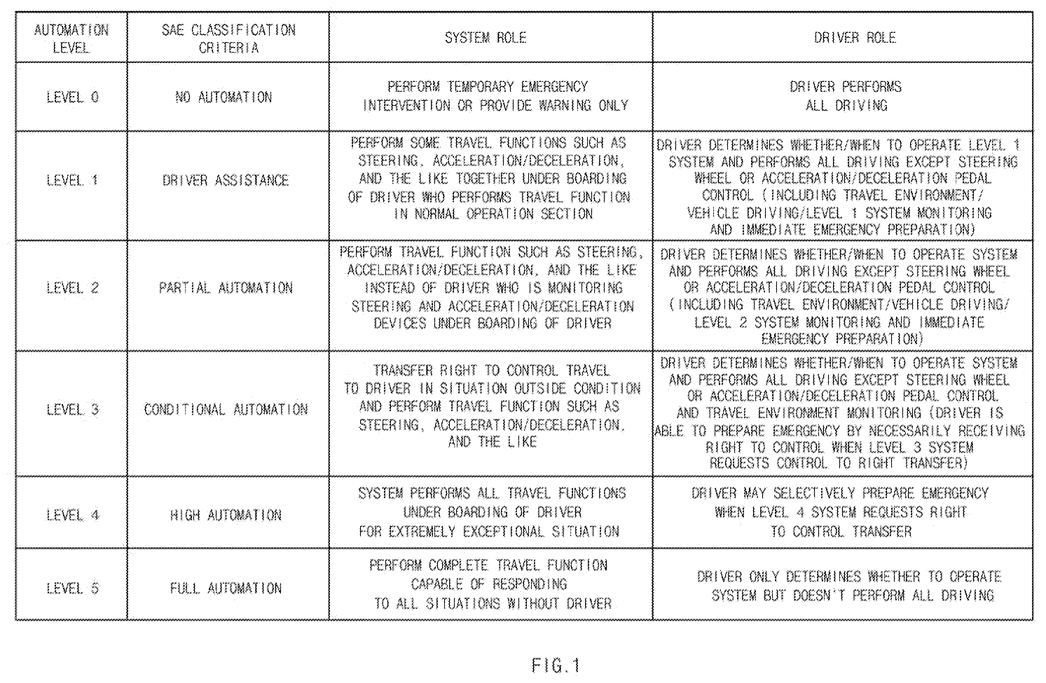

Hereinafter, some forms of the present disclosure will be described in detail with reference to FIGS. 1 to 7.

FIG. 1 is a table in which automation levels of an autonomous vehicle are defined.

The autonomous vehicle refers to a vehicle that recognizes a travel environment by itself to determine a risk, minimizes travel manipulation of a driver while controlling a travel route, and drives by itself.

Ultimately, the autonomous vehicle refers to a vehicle capable of traveling, controlling, and parking without an influence of humans, and is focused on a vehicle in a state in which an autonomous driving technology, which is a core foundation of the autonomous driving autonomous vehicle, that is, an ability to operate the vehicle without active control or monitoring of the driver is the most advanced.

Referring to FIG. 1, in an automation step level 0 to 2, the travel environment is monitored by the driver. On the other hand, in an automation step level 3 to 5, the travel environment is monitored by an automated travel system.

However, a concept of the autonomous vehicle currently being released may include an automation step of an intermediate step to the autonomous vehicle in a full sense, and corresponds to a goal-oriented concept on the premise of mass production and commercialization of a fully autonomous vehicle.

An autonomous driving control method according to the present disclosure may be applied to an autonomous vehicle corresponding to the level 2 (partial autonomous driving) and the level 3 (conditional autonomous driving) among automation steps of the autonomous driving shown in FIG. 1. However, the present disclosure may not be necessarily limited thereto, and the autonomous driving control method may be applied to an autonomous vehicle supporting a plurality of various automation steps.

The automation level of the autonomous vehicle based on the society of automotive engineers (SAE), which is an American association of automotive Engineers, may be classified as shown in the table in FIG. 1.

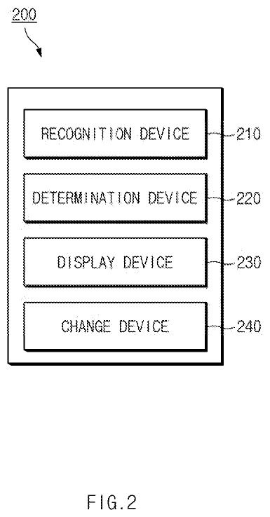

FIG. 2 is a block diagram for illustrating a structure of an autonomous driving control device in some forms of the present disclosure.

Referring to FIG. 2, an autonomous driving control device 200 may include a recognition device 210, a determination device 220, a display device 230, and a change device 240.

The recognition device 210 may recognize an external environment, a travel state, and the like during the autonomous driving to collect various information.

For example, external environment recognition information may include line recognition state information, current travel road type information, current travel road traffic volume information, current travel road accident and construction information, current weather information, communication state information, and the like, but the present disclosure may not be limited thereto.

For example, the travel state recognition information may include current travel speed information, vehicle speed behavior state information, vehicle operation state information, and the like. For example, the vehicle operation state information may include driving state information of a system necessary for the autonomous driving such as operation state information of a sensor such as a camera/a radar/a lidars, actuator operation state information, and the like.

The determination device 220 may determine whether a change in an autonomous driving level—that is, the automation level—is required based on the recognition result of the recognition device 210.

For example, the determination device 220 may determine whether level upward adjustment or level downward adjustment is required from a current autonomous driving level based on the recognition result.

The display device 230 may display at least one of a change information notification message and/or a change confirmation request message on a screen based on the determination result of the determination device 220.

The change device 240 may change the autonomous driving level based on a driver confirmation result—that is, an acceptance response of the driver to the change confirmation request-, or may automatically change the autonomous driving level after outputting the change information notification message.

The change device 240 may change the automation level based on a control signal received from a human machine interface (HMI) after the message output.

For example, when it is determined that the level downward adjustment by the determination device 220 is required, the display device 230 may output the change confirmation request message on the screen. In addition, when it is determined that the level upward adjustment by the determination device 220 is required, the display device 230 may output the corresponding change information notification message on the screen.

When the autonomous driving level needs to be adjusted downward based on the recognition result, more attention is required to the driver. In this case, the autonomous driving control device 200 may safely adjust the autonomous driving level downward after identification of the acceptance from the driver through a predetermined level change confirmation procedure.

On the other hand, when the autonomous driving level needs to be adjusted upward based on the recognition result, the attention of the driver is relatively less required compared to the current autonomous driving level. In this case, the autonomous driving control device 200 may automatically adjust the autonomous driving level upward after providing only level change information to the driver without the separate level change confirmation procedure.

As described above, the autonomous driving control device 200 according to the present disclosure may dynamically change the autonomous driving level without deactivating an autonomous driving mode based on the travel environment recognition result, thereby providing a continuous autonomous driving environment.

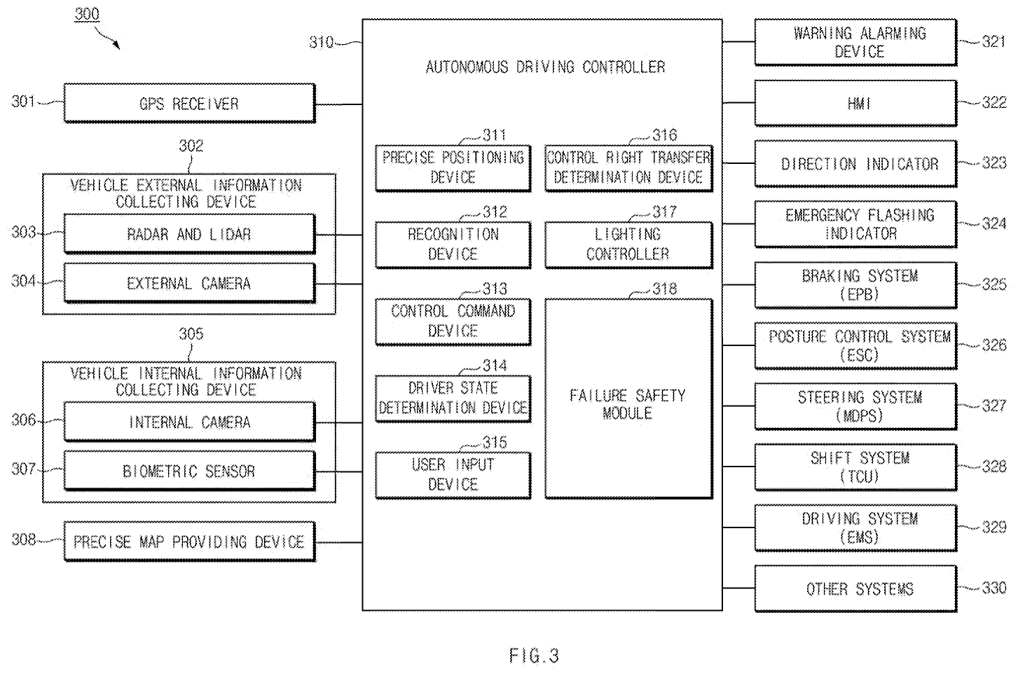

FIG. 3 is a block diagram for illustrating a structure of an autonomous driving control device in some forms of the present disclosure.

An autonomous driving control device 300 according to FIG. 3 may be mounted on an autonomous vehicle supporting an automation level equal to or higher than the level 3.

For convenience of description below, the autonomous driving control device 300 will be described by being simply referred to as the device 300.

Referring to FIG. 3, the device 300 may include a global positioning system (GPS) receiver 301, a vehicle external information collecting device 302, a vehicle internal information collecting device 305, a precise map providing device 308, an autonomous driving controller 310, a warning alarming device 321, a human machine interface (HMI) 322, a direction indicator 323, an emergency flashing indicator 324, a braking system 325, a posture control system 326, a steering system 327, a shift system 328, a driving system 329, and other systems 330.

Systems in association with the autonomous driving controller 310 are respectively equipped with control devices to monitor whether the systems are failed, and transmit the monitoring results to a failure safety module 318 of the autonomous driving controller 310.

The GPS receiver 301 may receive a positioning signal from a positioning satellite. In this connection, the positioning signal may be used to generate geographic location information of the vehicle.

The vehicle external information collecting device 302 may collect vehicle surrounding environment information and travel state information. The vehicle external information collecting device 302 may include a radar and a lidar 303, and an external camera 304.

The radar/lidar 303 may sense an object around the vehicle.

The radar/lidar 303 may sense objects in front of, to the side of, and at the rear of the vehicle, and calculate distances to the sensed objects.

In addition, the radar/lidar 303 may distinguish whether the sensed object is a static object or a dynamic object, measure a moving speed of the sensed dynamic object, and distinguish whether the sensed dynamic object is a pedestrian or a vehicle.

In addition, the radar/lidar 303 may be used for purposes such as identifying a state of a travel road and a facility through a high-resolution terrain scan.

The external camera 304 may be mounted on an exterior of the vehicle to take images of regions in front of, to the side of, and at the rear of the vehicle. To this end, the vehicle may be equipped with a plurality of external cameras.

The image taken by the external camera 304 may be used for line distinguishment, identification of the object around the vehicle, implementation of augmented reality, and the like.

The vehicle internal information collecting device 305 may collect various state information inside the vehicle.

The vehicle internal information collecting device 305 may include an internal camera 306 and a biometric sensor 307.

The internal camera 306 may be mounted on one side of an interior of the vehicle to photograph the driver and an occupant.

An image captured by the internal camera 306 may be used for monitoring a gaze direction of the driver, a state of the driver—for example, driver distraction, fatigue, drowsy driving, and the like.

The biometric sensor 307 may be mounted on one side of the vehicle to collect various biometric information of the driver.

The biometric sensor 307 may be in association with a wearable device of the driver to collect the various biometric information of the driver.

For example, the biometric information may include pulse information, heart rate monitoring information, body temperature information, blood alcohol concentration information, brainwave information, fingerprint recognition information, iris recognition information, and the like, but may not be limited thereto.

The biometric information may be used for determining a driving inability state, a drunk driving state, a drowsy driving state, and the like.

The precise map providing device 308 may provide precise map information in response to a request of the autonomous driving controller 310.

The warning alarming device 321 may output various warning alarm messages in response to a control signal from the autonomous driving controller 310. In this connection, the warning alarm message includes a visual message—for example, a screen output message-, an audible message—for example, a voice guide message-, a tactile message—for example, a vibration message-, and the like.

The warning alarming device 321 may include screen output means including a display, voice output means including a speaker, and vibration output means including a vibration motor, but may not be limited thereto.

The autonomous driving controller 310 may control to output one of the visual message, the audible message, and the tactile message based on a type of warning alarm, or to output a plurality of messages simultaneously or continuously in a predetermined order.

For example, when the change in the automation level is required, the autonomous driving controller 310 may control the message to be output through the different output means(s) based on a type of the change in the automation level.

For example, when the automation level downward adjustment is required, the message may be output using a larger number of message output means as the automation level is changed to a lower automation level.

As another example, when the automation level upward adjustment is required, the message may be output using a smaller number of message output means as the automation level is changed to a higher automation level.

The autonomous driving controller 310 may include a precise positioning device 311, a recognition device 312, a control command device 313, a driver state determination device 314, a user input device 315, a control right transfer determination device 316, a lighting controller 317, and the failure safety module 318.

The precise positioning device 311 may determine a current location of a host vehicle using positioning signal information received from the GPS receiver 301 and the precise map information obtained from the precise map providing device 308, and map the determined current location of the host vehicle on a precise map.

In addition, the precise positioning device 311 may identify state information—for example, a gradient, a road type, the number of lines, a speed limit, and the like—of a travel road of the host vehicle.

The recognition device 312 may recognize the line, the vehicle around the vehicle, an obstacle around the vehicle, the pedestrian, and the like based on sensing information from the radar/lidar 303 and image information captured by the external camera 304.

The recognition device 312 may be in association with the braking system 325, the posture control system 326, the steering system 327, the shift system 328, the driving system 329, and the like to recognize the travel state such as the vehicle speed, the vehicle speed behavior state (e.g., longitudinal/lateral acceleration), and the like of the vehicle.

The recognition device 312 may be in association with the failure safety module 318 and the like to recognize the operation states of the various sensors and actuators arranged in the vehicle.

The control command device 313 may calculate a request command value based on the recognition result of the recognition device 312, and transmit the calculated request command value to a corresponding autonomous driving system to perform travel control and autonomous driving level control.

The control command device 313 may determine whether it is possible to change the autonomous driving level based on the recognition result of the recognition device 312, and control the level change information notification message and/or the level change confirmation request message to be output based on the determination result.

In some forms of the present disclosure, when it is determined that the autonomous driving level downward adjustment is required, the control command device 313 may control the change confirmation request message for determining whether the driver accepts to be output on the screen. On the other hand, when it is determined that the autonomous driving level upward adjustment is required, the control command device 313 may control the change information notification message that does not require the identification of whether the driver accepts to be output on the screen.

When the autonomous driving level needs to be adjusted downward based on the recognition result, because more attention is required to the driver, the autonomous driving control device 200 in some forms of the present disclosure may safely adjust the autonomous driving level downward after identifying the acceptance for the level change from the driver through the predetermined autonomous driving level change confirmation procedure.

On the other hand, when the autonomous driving level needs to be adjusted upward based on the recognition result, the attention of the driver is relatively less required compared to the current autonomous driving level. Thus, the autonomous driving control device 200 in some forms of the present disclosure may automatically adjust the autonomous driving level upward after providing only the simple level change information to the driver without performing the separate level change confirmation procedure.

The driver state determination device 314 may determine the state of the driver based on the vehicle internal state information obtained from the vehicle internal information collecting device 305.

In this connection, the driver state may include the distracted state, the driving inability state, the drunk driving state, the drowsy driving state, the fatigue, and the like, but may not be limited thereto.

The user input device 315 may sense a user input based on a control signal received from the HMI 322.

In this connection, the user input may include a predetermined button input signal, a predetermined gesture input signal, and the like for accepting control right transfer from the system to the driver.

In addition, the user input may include a user response to the autonomous driving level change confirmation request.

The control right transfer determination device 316 may determine whether the control right transfer from the system to the driver is required based on at least one of the various recognition information obtained from the recognition device 312, the vehicle internal state information obtained from the vehicle internal information collecting device 305, and/or driver input information obtained from the user input device 315.

When the control right transfer is required as a result of the determination, the control right transfer determination device 316 may transmit a predetermined control signal to the warning alarming device 321 to control a predetermined warning alarm message requesting the control right transfer to the driver to be output.

The lighting controller 317 may control lighting of the direction indicator 323 and the emergency flashing indicator 324.

The failure safety module 318 may determine an optimal failure safety strategy based on a type of a failure sensed during the autonomous driving and a travel situation around the vehicle.

The failure safety module 318 may request the control command device 313 to perform vehicle control based on the determined failure safety strategy.

A detailed configuration and a detailed operation of the failure safety module 318 will become clearer through description of a drawing to be described later.

The braking system 325 may control an operation of an actuator related to the braking and monitor a state of the actuator.

As an example, the braking system 325 may include an electronic parking brake (EPB) that creates a braking force in an electronic manner rather than a physical force of a person.

The posture control system 326 may control an operation of an actuator for stably maintaining a posture of a vehicle body.

As an example, the posture control system 326 may include an electronic stability control (ESC), which is an advanced electronic braking device.

The ESC is a device that controls the posture of the vehicle through cooperative control of the braking force and a driving force of the vehicle. The ESC may provide anti-lock brake system (ABS) and traceability control system (TCS) functions together.

The electronic stability control (ESC) may determine whether the posture of the vehicle body is stably maintained by combining information measured by steering angle, lateral acceleration, yaw-rate, wheel speed sensors, and may operate in a scheme of controlling braking forces of four wheels independently based on such information.

The steering system 327 may control an operation of an actuator that controls a lateral behavior of the vehicle.

For example, the steering system 327 may include a motor driven power steering (MDPS). The MDPS is a device that assists driver handling using an electronic motor, not an oil pressure, which may include a dual power input structure and multiple signal channels for stable power supply and signal transmission/reception.

The shift system 328 may control an operation of an actuator for automatic shift.

As an example, the shift system 328 may include an automatic transmission control unit (TCU).

The transmission control unit (TCU) may determine a shift stage number and a timing based on a TPS, the vehicle speed, the number of engine rotations, a brake switch input, and the like to control an automatic transmission.

The driving system 329 may control an operation of an actuator that controls the longitudinal behavior—that is, the travel speed of the vehicle. For example, the actuator for controlling the longitudinal behavior may include a throttle, an accelerator, and the like.

For example, the driving system 329 may include an engine management system (EMS).

The EMS may perform electronic throttle control, gasoline direct injection, idle stop and go functions.

The other systems 330 may include a tire pressure measurement system for measuring a tire air pressure such as a tire pressure monitoring system (TPMS), a fuel tank sensing system, a battery management system disposed in a hybrid vehicle and an electric vehicle, and the like, but may not be limited thereto.

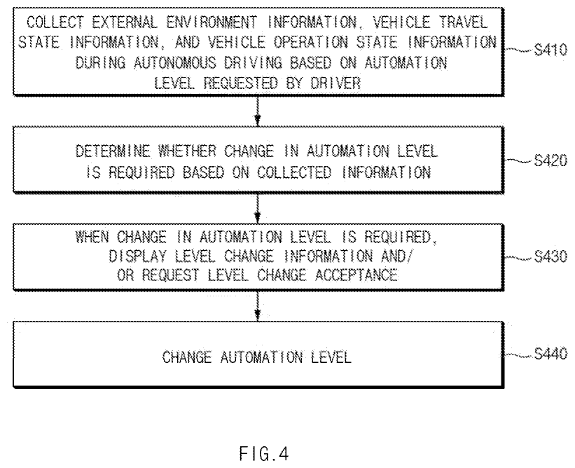

FIG. 4 is a flowchart for illustrating an autonomous driving level control method in an autonomous driving control device in some forms of the present disclosure.

Referring to FIG. 4, the autonomous driving control device may collect the external environment information, the vehicle travel state information, and the vehicle operation state information (S410).

The autonomous driving control device described in FIG. 4 may be the autonomous driving control devices 200 and 300 in FIGS. 2 to 3 above.

The autonomous driving control device may determine whether the change in the automation level—that is, the autonomous driving level—is required based on the collected information (S420).

For example, when a specific state “A” value recognized in a currently active automation level “X” is greater than a state “A” minimum value defined corresponding to an automation level “Y”, the autonomous driving control device may determine that the automation level upward adjustment is needed. In this connection, “Y” is an automation level higher than “X”.

For example, when the specific state “A” value recognized in the currently active automation level “X” is smaller than the state “A” maximum value defined corresponding to an automation level “Z”, the autonomous driving control device may determine that the automation level downward adjustment is needed. In this connection, “X” is an automation level higher than “Z”.

In the above example, it is described that whether to change the automation level is determined based on one state value, but this is only one form of the present disclosure. Whether to change the automation level may be determined by comparing a plurality of different state values based on a design of a person skilled in the art. For example, when all of level change conditions for each state A/B/C are satisfied, the level change may be made.

In some forms of the present disclosure, in the case of the automation level downward adjustment, a certain margin may be set for a predetermined threshold to minimize discomfort of the driver and a risk of accidents resulted from sudden level downward adjustment. Sufficient response preparation time of the driver for the level downward adjustment may be ensured through the corresponding margin.

When the change in the automation level is required, the autonomous driving control device may perform level change information display and/or level change acceptance request operations (S430).

The autonomous driving control device may change the automation level based on the acceptance response from the driver to the change in the automation level (S440). In this connection, the change in the automation level may be one of the automation level upward change and the automatic level downward change.

When it is determined that the automation level upward adjustment is required, an autonomous driving control device in some forms of the present disclosure may display only the level change information without performing the separate level change acceptance request/response procedure. In this case, when a certain time elapses after the level change information is displayed, the autonomous driving control device may automatically adjust the automation level upward.

When it is determined that it is required to change the automation level upward, an autonomous driving control device in some forms of the present disclosure may perform the level change acceptance request/response procedure after the level change information is displayed. In this case, the autonomous driving control device may adjust the automation level upward only when the level change acceptance response is received from the driver. On the other hand, when a level change rejection response is received from the driver, the autonomous driving control device may maintain a current automation level as it is.

When it is determined that automation level downward adjustment is required, the autonomous driving control device in some forms of the present disclosure may necessarily perform the level change acceptance request/response procedure. In this connection, when the level change acceptance response is received from the driver, the autonomous driving control device may adjust the automation level downward. On the other hand, when the level change rejection response is received from the driver, the autonomous driving control device may deactivate the autonomous driving mode—that is, the autonomous driving system.

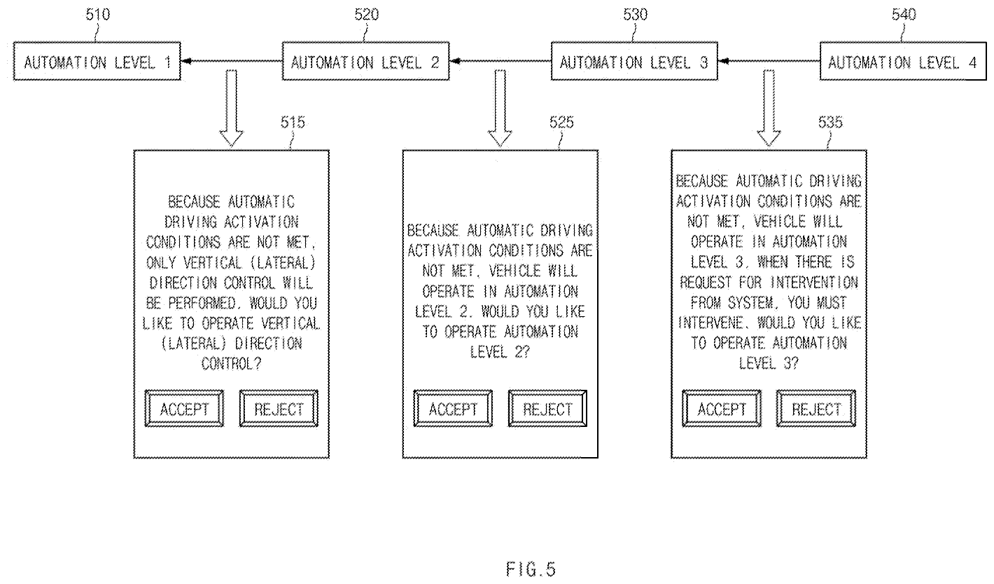

FIG. 5 is a diagram for illustrating an autonomous driving level downward adjustment procedure in some forms of the present disclosure.

Referring to FIG. 5, when it is determined that the automation level downward adjustment is required, the autonomous driving control devices 200 and 300 may output a message for identifying the acceptance/rejection of the driver for the level downward adjustment.

In some forms of the present disclosure, when a level downward adjustment from an automation level 2 520 to an automation level 1 510 is required, the autonomous driving control devices 200 and 300 may configure a first screen 515 including a guide phrase “Because automatic driving activation conditions are not met, only longitudinal (lateral) direction control will be performed. Would you like to operate the longitudinal (lateral) direction control?” and accept/reject buttons, and output the first screen 515 on one side of a provided display screen. For example, the display screen may include a cluster, but may not be limited thereto, and a head-up display and a navigation screen may be used as the display screen. In the automation level 1 510, at least one of a driving controller, a braking controller, and/or a steering controller may separately assist an autonomous driving function.

In some forms of the present disclosure, when a level downward adjustment from an automation level 3 530 to the automation level 2 520 is required, the autonomous driving control devices 200 and 300 may configure a second screen 525 including a guide phrase “Because automatic driving activation conditions are not met, the vehicle will operate in the automation level 2. Would you like to operate the automation level 2?” and accept/reject buttons, and output the second screen 525 on one side of the provided display screen. In the automation level 2 520, all the driving controller, the braking controller, and the steering controller may cooperate to assist the autonomous driving function. In addition, in the automation level 2 520, both longitudinal and lateral control rights are owned by the system, but the driver must continuously monitor the travel environment.

In some forms of the present disclosure, when a level downward adjustment from an automation level 4 540 to the automation level 3 530 is required, the autonomous driving control devices 200 and 300 may configure a third screen 535 including a guide phrase “Because automatic driving activation conditions are not met, the vehicle will operate in the automation level 3. When there is a request for intervention from the system, you must intervene. Would you like to operate the automation level 3?” and accept/reject buttons, and output the third screen 535 on one side of the provided display screen. In the automation level 3 530, all the driving controller, the braking controller, and the steering controller cooperate to assist the autonomous driving function, and the system monitors the surrounding environment. However, the driver must intervene in response to the intervention request from the system—for example, a control right transfer request and the like—at any time in the automation level 3 530.

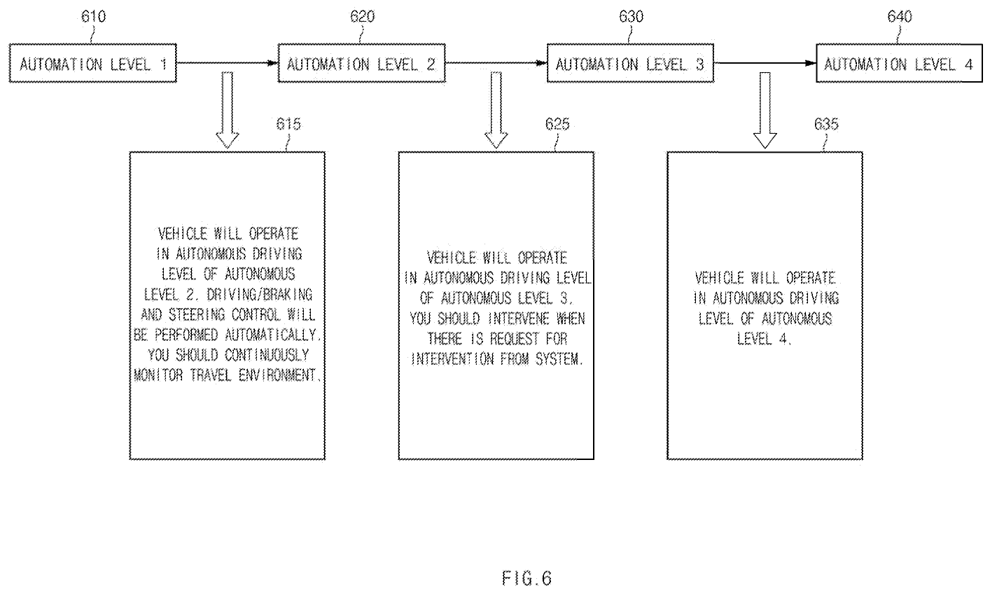

FIG. 6 is a view for illustrating an autonomous driving level upward adjustment procedure in some forms of the present disclosure.

Referring to FIG. 6, when it is determined that the automation level upward adjustment is required, the autonomous driving control devices 200 and 300 may output a guide message for the level upward adjustment.

In some forms of the present disclosure, when a level upward adjustment from an automation level 1 610 to an automation level 2 620 is required, the autonomous driving control devices 200 and 300 may configure a fourth screen 615 including a guide message “The vehicle will operate in the autonomous driving level of the autonomous level 2. Driving/braking and steering control will be performed automatically. You should continuously monitor the travel environment.”, and output the fourth screen 615 on one side of the display screen. For example, the display screen may include a cluster, but may not be limited thereto, and a head-up display and a navigation screen may be used as the display screen. In the automation level 2 620, all the driving controller, the braking controller, and the steering controller may cooperate to assist the autonomous driving function. In addition, in the automation level 2 620, both longitudinal and lateral control rights are owned by the system, but the driver must continuously monitor the travel environment.

In some forms of the present disclosure, when a level upward adjustment from the automation level 2 620 to an automation level 3 630 is required, the autonomous driving control devices 200 and 300 may configure a fifth screen 625 including a guide message “The vehicle will operate in the autonomous driving level of the autonomous level 3. You should intervene when there is the request for the intervention from the system.”, and output the fifth screen 625 on one side of the display screen. In the automation level 3 630, all the driving controller, the braking controller, and the steering controller cooperate to assist the autonomous driving function, and the system monitors the surrounding environment. However, the driver must intervene in response to the intervention request—for example, the control right transfer request and the like—from the system at any time in the automation level 3.

In some forms of the present disclosure, when a level upward adjustment from the automation level 3 630 to an automation level 4 640 is required, the autonomous driving control devices 200 and 300 may configure a sixth screen 635 including a guide message “The vehicle will operate in the autonomous driving level of the autonomous level 4.”, and output the sixth screen 635 on one side of the display screen. In the automation level 4 640, all the driving controller, the braking controller, and the steering controller may cooperate to assist the autonomous driving function, and the system may monitor the surrounding environment to respond without the separate intervention of the driver.

In FIGS. 5 to 6, the procedure for performing, by the autonomous driving control devices 200 and 300, the automation level adjustment in units of one level is described, but this is merely one form of the present disclosure. The autonomous driving control devices 200 and 300 in some forms of the present disclosure may perform automation level adjustment in units of two or more levels. For example, the upward adjustment may be made by 2 levels at a time from the automation level 1 to the automation level 3, or the downward adjustment may be made levels at a time from the automation level 4 to the automation level 2.

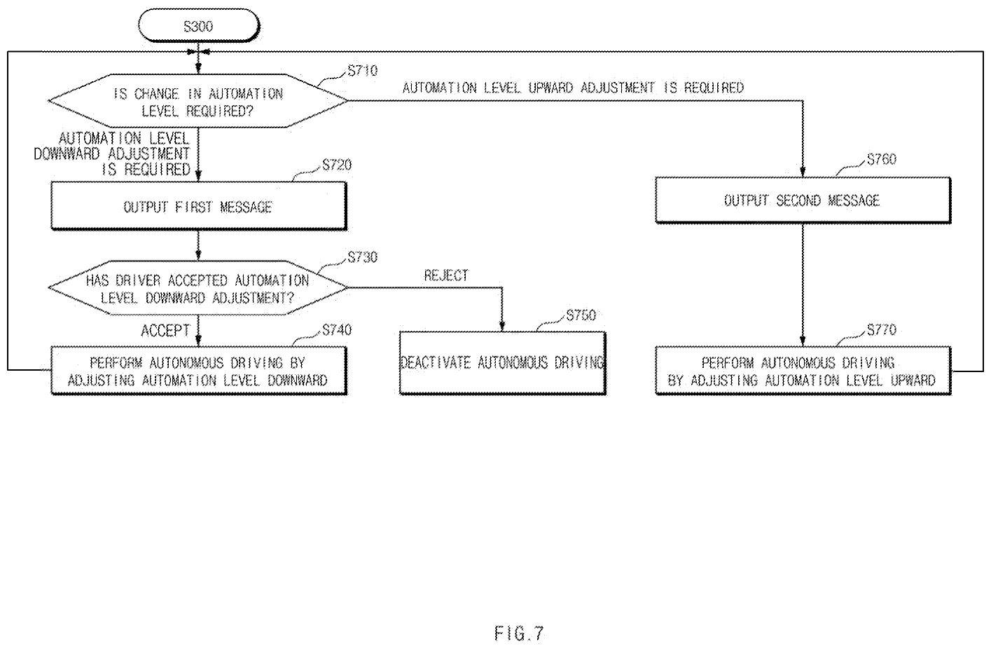

FIG. 7 is a flowchart for illustrating an operating mechanism of an autonomous driving control device in some forms of the present disclosure.

Referring to FIG. 7, the autonomous driving control devices 200 and 300 may determine whether the change in the automation level is required based on the recognition result during the autonomous driving (S710).

When the automation level downward adjustment is required as the result of the determination, the autonomous driving control devices 200 and 300 may output a first message requesting the driver acceptance for the corresponding automation level downward adjustment (S720).

The autonomous driving control devices 200 and 300 may determine whether the driver has accepted the automation level downward adjustment (S730).

The autonomous driving control devices 200 and 300 may perform the autonomous driving by adjusting the automation level downward when receiving an acceptance response from the driver for the first message (S740).

The autonomous driving control devices 200 and 300 may deactivate the autonomous driving when receiving a rejection response from the driver for the first message (S750).

When the automation level upward adjustment is required as the result of the determination in (S710), the autonomous driving control devices 200 and 300 may output a second message for guiding the corresponding automation level upward adjustment (S760).

Thereafter, the autonomous driving control devices 200 and 300 may adjust the automation level upward to perform the autonomous driving (S770). As an example, the autonomous driving control devices 200 and 300 may automatically adjust the automation level upward when a certain time elapses after the second message is output.

In some forms of the present disclosure, the autonomous driving control devices 200 and 300 may perform the automation level upward adjustment after identifying the acceptance from the driver for the automation level upward adjustment even when the automation level upward adjustment is required.

The operations of the method or the algorithm described in some forms of the present disclosure may be embodied directly in hardware or a software module executed by the processor, or in a combination thereof. The software module may reside on a storage medium (that is, the memory and/or the storage) such as a RAM, a flash memory, a ROM, an EPROM, an EEPROM, a register, a hard disk, a removable disk, and a CD-ROM.

The exemplary storage medium may be coupled to the processor, and the processor may read information out of the storage medium and may record information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure claimed in the following claims. Therefore, the exemplary forms of the present disclosure are provided to explain the spirit and scope of the present disclosure, but not to limit them, so that the spirit and scope of the present disclosure is not limited by the forms. The scope of the present disclosure should be construed on the basis of the accompanying claims, and all the technical ideas within the scope equivalent to the claims should be included in the scope of the present disclosure.

The present disclosure has an advantage of providing the method and the device for controlling the autonomous driving capable of adaptively switching the automation level of the autonomous driving.

In addition, the present disclosure has an advantage of providing the method and the device for controlling the autonomous driving capable of adaptively controlling the automation steps without deactivating the autonomous driving based on the change in the environment during the autonomous driving, thereby providing continuous autonomous driving.

In addition, the autonomous driving control device according to the present disclosure has an advantage of adaptively performing the guide message output and/or the driver confirmation procedures depending on whether the automation level adjustment is the downward adjustment or the upward adjustment, thereby minimizing driver inconvenience.

In addition, the present disclosure has an advantage of effectively preventing an occurrence of additional dangerous situations from a point of view of the driver resulted from sudden autonomous driving mode deactivation by performing at least one of the automation level change guide message output and/or the driver confirmation procedures without the autonomous driving deactivation in a situation in which the change in the automation level is required to safely change the automation level.

In addition, various effects that are directly or indirectly identified through the present document may be provided.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for controlling autonomous driving in an autonomous vehicle comprising:
collecting recognition information during the autonomous driving;
determining whether a change in an automation level is required based on the collected recognition information;
displaying a predetermined message on a screen when it is determined that the change in the automation level is required; and
performing the autonomous driving by changing the automation level when it is determined that the change in the automation level is required.

2. The method of claim 1, wherein the recognition information includes at least one of external environment recognition information, travel state recognition information, driver state recognition information, precise map information, or vehicle operation state information.

3. The method of claim 2, further comprising:
when it is determined that downward adjustment of the automation level is required, displaying a first message including an automation level change guide phrase and buttons for determining whether a driver accepts a corresponding change in the automation level on the screen.

4. The method of claim 3, further comprising:
when it is determined that the driver accepts the corresponding change in the automation level, performing the autonomous driving after the automation level is adjusted downward; and
when it is determined that the driver does not accept the corresponding change in the automation level, deactivating the autonomous driving.

5. The method of claim 1, further comprising:
displaying a second message including an automation level change guide phrase on the screen; and
not determining whether a driver accepts the change in the automation level when it is determined that upward adjustment of the automation level is required.

6. The method of claim 5, wherein the change in the automation level includes a change of at least two levels.

7. The method of claim 1, further comprising:
performing the change in the automation level based on a control signal received from a human machine interface (HMI) after displaying the predetermined message.

8. The method of claim 2, wherein the external environment recognition information includes at least one of line recognition state information, current travel road type information, current travel road traffic volume information, current travel road accident and construction information, current weather information, or communication state information.

9. The method of claim 1, wherein displaying the predetermined message comprises:
displaying the predetermined message using at least one of a visual output, an audible output, or a tactile output.

10. The method of claim 9, further comprising:
when it is determined that downward adjustment of the automation level is required, outputting the predetermined message using a larger number of output as the automation level is changed to a lower level; and
when it is determined that upward adjustment of the automation level is required, outputting the predetermined message using a smaller number of output as the automation level is changed to a higher level.

11. A device for controlling autonomous driving in an autonomous vehicle, the device comprising:
a recognition device configured to collect recognition information during the autonomous driving;
a determination device configured to determine whether a change in an automation level is required based on the collected recognition information;
a display device configured to display a predetermined message on a screen when it is determined that the change in the automation level is required; and
a change device configured to perform the autonomous driving by changing the automation level when it is determined that the change in the automation level is required.

12. The device of claim 11, wherein the recognition information includes at least one of external environment recognition information, travel state recognition information, driver state recognition information, precise map information, or vehicle operation state information.

13. The device of claim 12, wherein the display device is configured to:
display, on the screen, a first message including an automation level change guide phrase and buttons for determining whether a driver accepts the corresponding change in the automation level when it is determined that downward adjustment of the automation level is required.

14. The device of claim 13, wherein the change device is configured to:
perform the autonomous driving after the automation level is adjusted downward when it is determined that the driver accepts the corresponding change in the automation level; and
deactivate the autonomous driving when it is determined that the driver does not accept the corresponding change in the automation level.

15. The device of claim 11, wherein the display device is configured to:
display, on the screen, a second message including an automation level change guide phrase; and
not determine whether a driver accepts the change in the automation level when it is determined that upward adjustment of the automation level is required.

16. The device of claim 15, wherein the display is configured to:
not determine whether the driver accepts a change of at least two levels in the automation level.

17. The device of claim 11, wherein the change device is configured to:
perform the change in the automation level based on a control signal received from a human machine interface (HMI) after displaying the predetermined message.

18. The device of claim 12, wherein the external environment recognition information includes at least one of line recognition state information, current travel road type information, current travel road traffic volume information, current travel road accident and construction information, current weather information, or communication state information.

19. The device of claim 11, wherein the display device is configured to:
display the predetermined message using at least one of a visual output, an audible output, or a tactile output.

20. The device of claim 19, wherein the display device is configured to:
output the predetermined message using a larger number of output as the automation level is changed to a lower level when it is determined that downward adjustment of the automation level is required; and
output the predetermined message using a smaller number of output as the automation level is changed to a higher level when it is determined that upward adjustment of the automation level is required.
